(19) United States
(12) Patent Application Publication
(10) Pub. No.: US 2010/0064846 A1
(43) Pub. Date: Mar. 18, 2010

(54) PEDAL ASSEMBLY

(76) Inventor: WEN-FENG TSAI, Ta-Li City (TW)

Correspondence Address: Dr. BANGER SHIA, 102 Lindencrest Ct., Sugar Land, TX, 77479-5201, US

(21) Appl. No.: 12/212,584

(22) Filed: Sep. 17, 2008

(51) Int. Cl. B62M 3/08

(52) U.S. Cl. 74/594.4

(57) ABSTRACT

A pedal assembly for a bicycle comprises a pedal body, a shaft, an anti-leakage unit and an engaging unit. The pedal body is provided in one side thereof with a first through hole for an accommodation of a first shaft sleeve, and in the other opposite side thereof with a second through hole for an accommodation of a second shaft sleeve. The shaft is provided with a flange and penetrates the first shaft sleeve and the second shaft sleeve. The anti-leakage unit including a first elastic element is mounted on the shaft. The engaging unit including a second elastic element is mounted on the distal end of the shaft. By such arrangements, since the first and the second elastic elements have the function of elastic recovery, the clearance caused due to abrasion can be effectively eliminated, and the rotating speed of the pedal body can be suppressed.

### BACKGROUND OF THE INVENTION

1. Field of the Invention

The present invention relates to bicycle parts, and more particularly to a pedal assembly for a bicycle, the rotating speed of which can be effectively suppressed.

2. Description of the Prior Art

In order to prevent excessive rotation of the bicycle pedal from causing inconvenience and danger to the rider, a pedal assembly capable of reducing pedal rotating speed has been developed on the market, as shown in FIG. 4, the conventional pedal assembly essentially comprises a pedal body 5 and a spindle 6. The pedal body 5 has one end defined with a first inserting hole 51 in which is engaged a first bush 52. The pedal body 5 has the other end defined with a second inserting hole 53 coaxial with the first inserting hole 51. A second bush 54 is engaged in the second inserting hole 53.

One end of the spindle 6 is attached to a crank of the bicycle (not shown) and provided with a flange 61 at a predetermined position thereof A first pressing ring 62 is mounted on the spindle 6 and abuts against the flange 61. By such arrangements, when the spindle 6 is inserted through the first inserting hole 51 to the second inserting hole 53, the first pressing ring 62 is located between the flange 61 and the first bush 52. In addition, a second pressing ring 62 is further mounted on the spindle 6 and has one end abutting against one end of the second bush 54. The other end of the pressing ring 62 is provided with a stop ring 64 mounted on the spindle 6. The other end of the spindle 6 is engaged with an engaging member for fixing the spindle 6.

As known from the abovementioned, when the pedal body 5 is operated, although the spindle 6 is fixedly combined to the crank without self-rotation, the first and the second bushes 52 and 54 between the spindle 6 and the pedal body 5 can make the spindle 6 rotate relative to the pedal body 5. Therefore, when the pedal body 5 is forced to rotate, friction will be caused between the first pressing ring 62 and the first bush 52, and between the second pressing ring 63 and the second bush 54, thus suppressing the rotating speed of the pedal body 5. Accordingly, the bearing surface of the pedal body 5 is possibly retained in a horizontal orientation to facilitate the user to step on the pedal body 5 and avoid of inconvenience and dangers caused due to the bearing surface being not horizontal.

To summarize, although the rotating speed of the pedal body 5 can be suppressed, the above conventional pedal assembly still suffers from the following disadvantages:

1. The clearance will be caused therein since the thickness of the respective pressing rings 62, 63 will decrease due to long-term friction loss, with the clearance, the pedal body 5 will slide laterally on the spindle 6, thus adversely affecting the function of suppressing the rotating speed of the pedal body 5, as a result, it is difficult to retain the pedaling surface of the pedal body 5 substantially in a horizontal orientation, so that the user is likely to miss his footing while stepping on the pedal body 5.

2. When the pedal body 5 is subjected to a force, the pedal body 5 will produce a lateral force, since the second pressing ring 63 doesn't have the capability of absorbing force, after being pressed by the lateral force, the second pressing ring 63 can only bear the lateral force, so that the second pressing ring 63 is directly pressed by the lateral force, thus accelerating the abrasion speed.

The present invention has arisen to mitigate and/or obviate the afore-described disadvantages.

### SUMMARY OF THE INVENTION

The primary objective of the present invention is to provide a pedal assembly for a bicycle, the rotating speed of which can be effectively limited to make the user operate the pedal assembly more conveniently and safely.

In order to achieve the above objective, a pedal assembly in accordance with the present invention comprises a pedal body, a shaft, an anti-leakage unit and an engaging unit. The pedal body is provided in one side thereof with a first through hole and a first shaft sleeve disposed in the first through hole, and in the other opposite side thereof with a second through hole coaxial with the first through hole and a second shaft sleeve disposed in the second through hole. The shaft penetrates the first shaft sleeve and the second shaft sleeve, one end of the shaft is formed with a combining portion, and the other end of the shaft is formed with a rod portion, the shaft is further formed with a flange between the two ends thereof, the rod portion of the shaft penetrates the respective shaft sleeves, the rod portion has a distal end provided with an engaging portion, which is defined with a first limiting groove. The anti-leakage unit includes a first elastic element, which is disposed on the rod portion to abut against the pedal body, and the first elastic element is located between the pedal body and the flange. The engaging unit is disposed on the engaging portion and provided with a first engaging member, which is engaged in the first limiting groove.

With the above structure, the present invention can offer the following functions:

1. The first elastic element has the function of elastic recovery, so that the clearance caused due to the abrasion of the first elastic element can be immediately eliminated, and further, the friction between the first elastic element and the pedal can be effectively kept to suppress the rotating speed of the pedal body

2. If the pedal body is subjected to a force to produce a lateral force, the first elastic element can absorb the lateral force, but if the pedal body doesn't be forced any longer, the first elastic element will restore to its natural state, therefore, the abrasion of the first elastic element can be reduced, thus extending the service life.

### BRIEF DESCRIPTION OF THE DRAWINGS

FIG. 1 is a perspective view of a pedal assembly for a bicycle in accordance with the present invention;

FIG. 2 is an exploded view of the pedal assembly for a bicycle in accordance with the present invention;

FIG. 3 is a cross-sectional view of the pedal assembly for a bicycle in accordance with the present invention; and

FIG. 4 is a perspective view of a conventional pedal assembly:

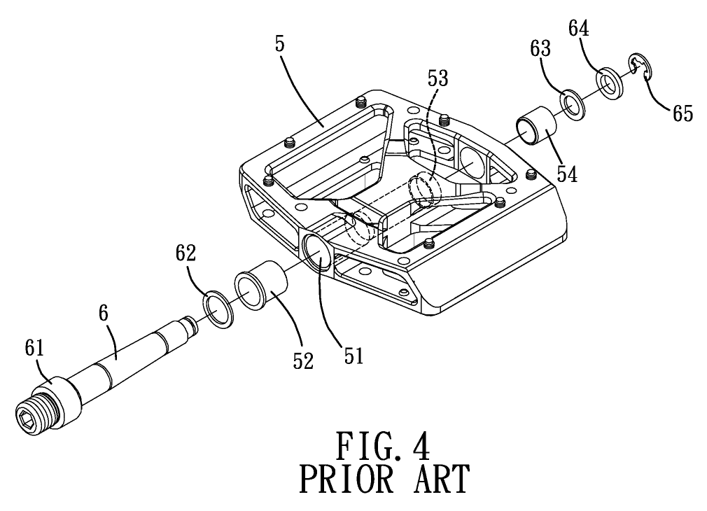

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

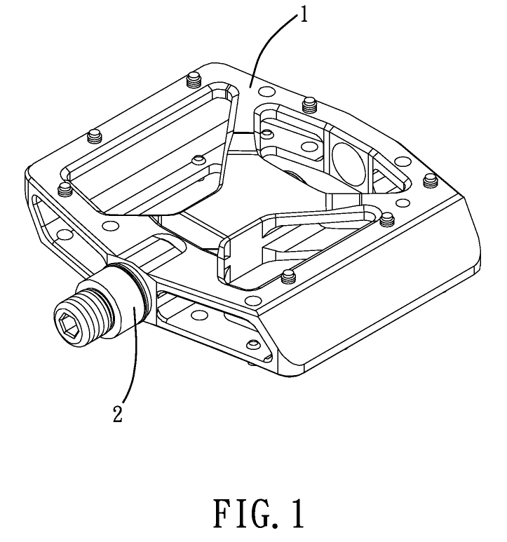

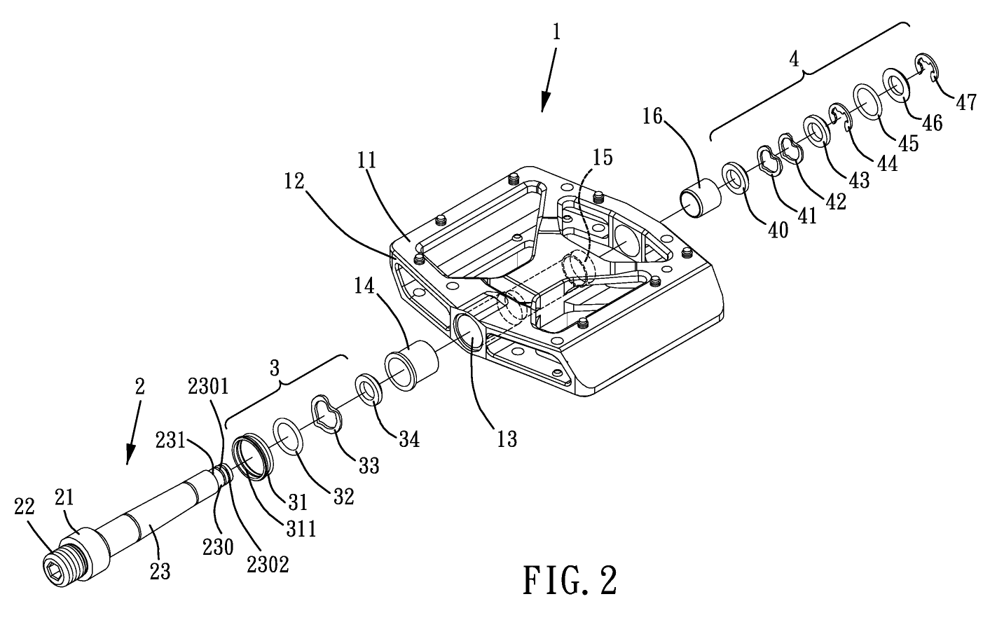

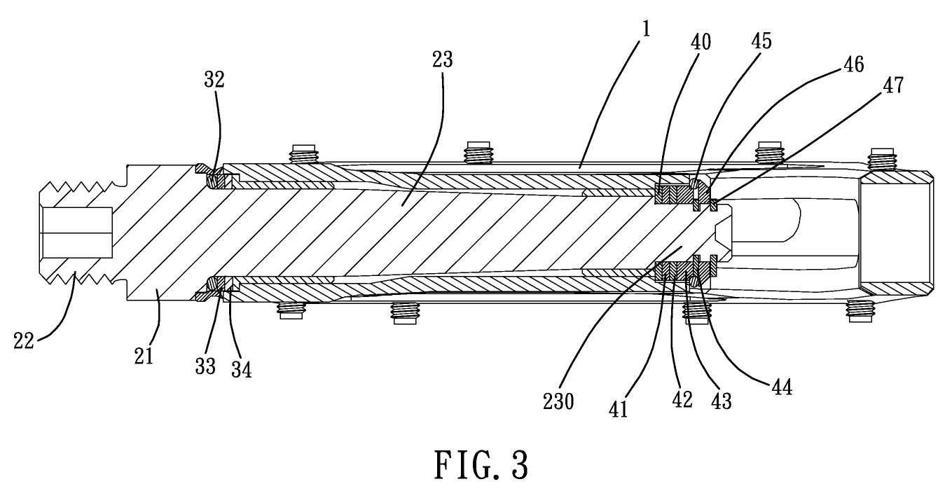

Referring to FIGS. 1-3, a pedal assembly for a bicycle in accordance with a preferred embodiment of the present invention comprises a pedal body 1, a shaft 2, an anti-leakage unit 3 and an engaging unit 4.

The pedal body 1 includes of a pair of opposed loading portions 11, and a pair of opposed fixing portions 12 connected to the two loading portions 11. One of the fixing portions 12 is defined with a first through hole 13 at a predetermined position thereof. In the first through hole 13 is engaged a first through shaft sleeve 14, which may be a bearing. The other of the fixing portions 12 is defined with second through hole 15 coaxial with the first through hole 13. In the second through hole 15 is engaged a second through shaft sleeve 16, which may also be a bearing.

The shaft 2 is a conical rod formed with a flange 21 and penetrates the first shaft sleeve 14 and the second shaft sleeve 16. The shaft 2 has one end formed with a combining portion 22 to be attached to a crank (not shown), so that when the user steps on the pedal body 1, the shaft 2 will drive the crank to make the bicycle move. In addition, the shaft 2 has the other end formed with a rod portion 23 for engagement with the anti-leakage unit 3. The distal end of the rod portion 23 is provided with a step-like engaging portion 230 to be engaged to the engaging unit 4. The engaging portion 230 is radially formed with an engaging surface 231. The engaging portion 230 is defined with a first limiting groove 2301 and a second limiting groove 2302 at two predetermined positions thereof.

The anti-leakage unit 3 includes a bush 31, an anti-leakage ring 32, a first elastic element 33 and a first washer 34. The bush 31 includes a groove 311 in an inner circumferential surface and has one end abutting against the flange 21. The anti-leakage ring 32 is disposed in the groove 311 of the bush 31. The first elastic element 33 is disposed at the other end of the bush 31. The first elastic element 33 can be a wave washer, a spring washer or a warp disc spring. Additionally, the first washer 34 is disposed between the first elastic element 33 and the first shaft sleeve 14.

The engaging unit 4 includes a second washer 40, a second elastic element 41, a third elastic element 42, a third washer 43, a first engaging member 44, an anti-leakage ring 45, a pressing ring 46 and a second engaging member 47. The second washer 40, the second elastic element 41 are successively mounted on the engaging portion 230 in such a manner that the second washer 40 abuts against the engaging surface 231. The third elastic element 42 abuts against the second elastic element 41. The third elastic element 42 and the second elastic element 43 can be wave washers, spring washers or warp disc springs. The third washer 43 is pressed against the third elastic element 42. In addition, the first engaging member 44 is engaged in the first limiting groove 2301 to limit the second washer 40, the second elastic element 41, the third elastic element 42 and the third washer 43 to abut against one another, so as to make the second elastic element 41 and the third elastic element 42 press against the second washer 40, thus increasing the friction between the second washer 40 and the second shaft sleeve 16. In addition, the anti-leakage ring 45 and the pressing ring 46 are successively mounted on the engaging portion 230 and located behind the first engaging member 44. The second engaging member 47 is engaged in the second limiting groove 2302 to limit the anti-leakage ring 45 and the pressing ring 46 between the first engaging member 44 and the second engaging member 47.

As known from the abovementioned, when the pedal body 1 is combined to the shaft 2, the first shaft sleeve 14 and the second shaft sleeve 16 are engaged in the first through hole 13 and the second through hole 15, respectively, and then the bush 31, the anti-leakage ring 32, the first elastic element 33 and the first washer 34 are successively mounted on the rod portion 23 of the shaft 2. At this moment, the shaft 2 penetrates the first shaft sleeve 14 and the second shaft sleeve 16 in such a manner that the engaging portion 230 of the shaft 2 protrudes out of the second shaft sleeve 16, and the second washer 40, the second elastic element 41, the third elastic element 42 and the third washer 43 are then mounted on the engaging portion 230 successively and positioned therein through the engagement of the first engaging member 44 and the first limiting groove 2301. Ultimately, the anti-leakage ring 45 and the pressing ring 46 are mounted on the engaging portion 230 behind the first engaging member 44 and retained therein through the engagement of the second engaging member 47 in the second limiting groove.

By such arrangements, the first elastic element 33 can utilize its elastic recovery force to make the first washer 34 substantially abut against the first shaft sleeve 14, and the second elastic element 41 can also utilize its elastic recovery force to make the second washer 40 substantially abut against the second shaft sleeve 16, thus causing friction therebetween to suppress the rotating speed of the pedal body.

To summarize, it can be found that the present invention has the following advantages:

1. The first elastic element 33, the second elastic element 41 and the third elastic element 42 all have the function of elastic recovery, so that the clearance caused due to the abrasion of the first and the second washer 34, 40 can be immediately eliminated, and therefore, the friction between the respective washers 34, 40 and the respective shaft sleeve 14, 16 can be effectively kept to suppress the rotating speed of the pedal body 1 in such a manner that the pedaling surface of the pedal body 1 can be retained in a horizontal orientation for the user to step on successfully, if the respective elastic elements 33, 41, 42 are a wave washer, a spring washer or warp spring, the respective elastic elements can substitute for the first and the second washers 34, 40, which can suppress the rotating speed of the pedal body and has the elastic recovery function.

2. If the pedal body is subjected to a force to produce a lateral force, the second elastic element 41 and the third elastic element 42 can absorb the lateral force, but if the pedal body doesn't be forced any longer, the second elastic element 41 and the third elastic element 42 can restore to their natural state, therefore, the abrasion of the second washer can be reduced, thus extending the service life, likewise, if the respective elastic elements 33, 41, 42 are a wave washer, an elastic washer or a warp spring, they can also substitute for the first and the second washers 34, 40 to achieve the same function.

While we have shown and described various embodiments in accordance with the present invention, it is clear to those skilled in the art that further embodiments may be made without departing from the scope of the present invention.

What is claimed is:

1. A pedal assembly for a bicycle comprising a pedal body, a shaft, an anti-leakage unit and an engaging unit; wherein:
the pedal body is provided in one side thereof with a first through hole and a first shaft sleeve disposed in the first through hole, and in the other opposite side thereof with a second through hole coaxial with the first through hole and a second shaft sleeve disposed in the second through hole;
the shaft penetrates the first shaft sleeve and the second shaft sleeve, one end of the shaft is formed with a combining portion, and the other end of the shaft is formed with a rod portion, the shaft is further formed with a flange between the two ends thereof, the rod portion of the shaft penetrates the respective shaft sleeves, the rod portion has a distal end provided with an engaging portion, the engaging portion is defined with a first limiting groove;
the anti-leakage unit includes a first elastic element, which is disposed on the rod portion to abut against the pedal body, and the first elastic element is located between the pedal body and the flange; and
the engaging unit is disposed on the engaging portion and provided with a first engaging member, which is engaged in the first limiting groove.

2. The pedal assembly as claimed in claim 1, wherein the engaging portion of the shaft is step-like.

3. The pedal assembly as claimed in claim 1, wherein the engaging portion of the shaft is radially formed with an engaging surface and further defined with a second limiting groove.

4. The pedal assembly as claimed in claim 1, wherein the shaft is in the form of a conical rod.

5. The pedal assembly as claimed in claim 1, wherein the respective shaft sleeves are a bearing.

6. The pedal assembly as claimed in claim 1, wherein the anti-leakage unit further includes a bush, an anti-leakage ring and a first washer, the bush is defined with a groove in an inner circumferential surface thereof and abuts against the flange, the anti-leakage ring is disposed in the groove, the first elastic element is disposed between the bush and the first washer, the first washer abuts against the first shaft sleeve.

7. The pedal assembly as claimed in claim 1, wherein the engaging unit further includes a second washer, a second elastic element, a third elastic element, a third washer, an anti-leakage ring, a pressing ring and a second engaging member, the second washer, the second elastic element, the third elastic element and the third washer are successively disposed between the second shaft sleeve and the first engaging member, the second washer abuts against the engaging surface, the third washer abuts against the first engaging member, the anti-leakage ring and the pressing ring are successively disposed behind the first engaging member, the second engaging member is engaged in the second limiting groove.

8. The pedal assembly as claimed in claim 1, wherein the first elastic element is a wave washer.

9. The pedal assembly as claimed in claim 1, wherein the first elastic element is a spring washer.

10. The pedal assembly as claimed in claim 1, wherein the first elastic element is a warp disc spring.

11. A pedal assembly for a bicycle comprising a pedal body, a shaft and an engaging unit; wherein:
the pedal body is provided in one side thereof with a first through hole and a first shaft sleeve disposed in the first through hole, and in the other opposite side thereof with a second through hole coaxial with the first through hole and a second shaft sleeve disposed in the second through hole;
the shaft penetrates the first shaft sleeve and the second shaft sleeve, one end of the shaft is formed with a combining portion, and the other end of the shaft is formed with a rod portion, the shaft is further formed with a flange between the two ends thereof, the rod portion of the shaft penetrates the respective shaft sleeves, the rod portion has a distal end provided with an engaging portion, the engaging portion is defined with a first limiting groove; and
the engaging unit is disposed on the engaging portion and includes a second elastic element and a first engaging member, the first engaging member is engaged in the first limiting groove, the second elastic element abuts against the pedal body and is located between the pedal body and the first engaging member.

12. A pedal assembly for a bicycle comprising a pedal body, a shaft, an anti-leakage unit an engaging unit; wherein:
the pedal body is provided in one side thereof with a first through hole and a first shaft sleeve disposed in the first through hole, and in the other opposite side thereof with a second through hole coaxial with the first through hole and a second shaft sleeve disposed in the second through hole;
the shaft penetrates the first shaft sleeve and the second shaft sleeve, one end of the shaft is formed with a combining portion, and the other end of the shaft is formed with a rod portion, the shaft is further formed with a flange between the two ends thereof, the rod portion of the shaft penetrates the respective shaft sleeves, the rod portion has a distal end provided with an engaging portion, the engaging portion is defined with a first limiting groove; and
the anti-leakage unit includes a first elastic element, which is disposed on the rod portion to abut against the pedal body, and the first elastic element is located between the pedal body and the flange; and
the engaging unit is disposed on the engaging portion and includes a second elastic element and a first engaging member, the second elastic element abuts against the second shaft sleeve and is located between the second shaft sleeve and the first engaging member.

13. The pedal assembly for a bicycle as claimed in claim 11, the elastic elements each are a wave washer.

14. The pedal assembly for a bicycle as claimed in claim 12, the elastic elements each are a wave washer.

15. The pedal assembly for a bicycle as claimed in claim 11, the elastic elements each are a spring washer.

16. The pedal assembly for a bicycle as claimed in claim 12, the elastic elements each are a spring washer.

17. The pedal assembly for a bicycle as claimed in claim 11, the elastic elements each are a warp disc spring.

18. The pedal assembly for a bicycle as claimed in claim 12, the elastic elements each are a warp disc spring.
